(19) United States
(12) Patent Application Publication
(10) Pub. No.: US 2007/0294550 A1
(43) Pub. Date: Dec. 20, 2007

(54) Memory Management With Defragmentation In A Computing Device

(75) Inventors: Dennis May, London (GB); Jonathan Harris, London (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: Symbian Software Limited, London (GB)

(21) Appl. No.: 10/595,274

(22) PCT Filed: Sep. 29, 2004
(86) PCT No.: PCT/GB04/04152

§ 371 Date: Mar. 29, 2007

(30) Foreign Application Priority Data
Oct. 4, 2003 (GB) 0323302.0

(51) Int. Cl. G06F 1/32; G06F 12/00

(52) U.S. Cl. 713/320; 711/104

(57) ABSTRACT

Data held in physical memory, such as random access memory, in a computing device is defragmented when a system operating code null thread, which is used for placing the computing device into a reduced power mode when no other thread in the system is ready to run, is scheduled to run.

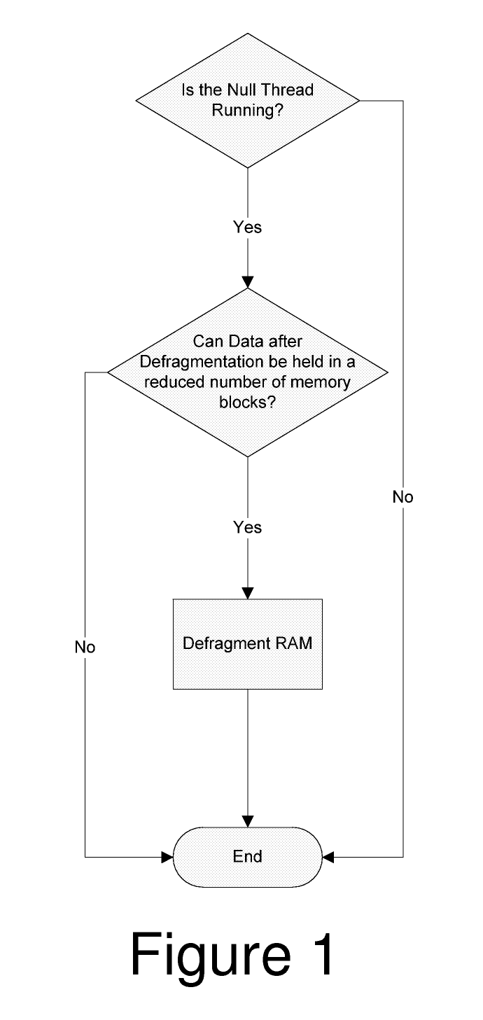

The present invention relates to a method for managing memory in a computing device.

The term computing device as used herein is to be expansively construed to cover any form of electrical device and includes, data recording devices, such as digital still and movie cameras of any form factor, computers of any type or form, including hand held and personal computers, and communication devices of any form factor, including mobile phones, smart phones, communicators which combine communications, image recording and/or playback, and computing functionality within a single device, and other forms of wireless and wired information devices.

Most computing devices are programmed to operate under the control of an operating system. The operating system controls the computing device by way of a series of instructions, in the form of code, fed to a central processing unit of the device. These instructions can be regarded as a series of quasi-autonomous fundamental units of execution which are scheduled by the operating system. These fundamental units of execution are respectively known as threads and a process to be carried out in the computing device will invariably include one or more threads.

A typical operating system will schedule many different threads in order to control the variety of tasks to be carried out by the computing device. One of these threads, often referred to as the ‘null’ thread or ‘idle’ thread, is distinguished from all other threads in that it runs if, and only if, there are no other threads eligible for execution (ready to run), i.e. if the system is, in essence, idle. For certain systems, the idle thread is the first thread to be sequenced by the operating system at boot time of the computing device. As. is explained in greater detail below, the operating system can be regarded as being made up of a number of components and some of these components have a more privileged access to the hardware resources of the computing device than other components. One or more of these privileged components form what is commonly known as the kernel of the operating system and in certain operating systems the null thread is responsible for the first phases of kernel initialisation. After these initial phases, the null thread will usually only again be scheduled by the operating system when no other thread is ready to run.

With the present invention, it has been realised that because the null thread is scheduled when no other thread is ready to run, the task of defragmenting physical memory resources of the computing device, such as RAM or disc storage within or used in association with the computing device, can be performed to particular advantage during running of the null thread.

According to a first aspect of the present invention there is provided a method of managing memory resource in a computing device, the method comprising using a thread of operating system code for causing the computing device to adopt a reduced power mode to initiate defragmentation of data held in memory resource in the computing device.

According to a second aspect of the present invention there is provided a computing device arranged to operate in accordance with the method of the first aspect.

According to a third aspect of the present invention there is provided a computer program for causing memory management in a computing device in accordance with the method of the first aspect.

The present invention will now be described, by way of further example only, with reference to a particular embodiment.

Many different forms of computing device are available and it follows that some devices have restricted physical resources, such as less memory resources or a slower CPU, in comparison to other devices. One type of computing device that has restricted physical resources is a wireless information device in the form of a smart phone. This is because, in essence, the smart phone is a computing device that is intended to run on a mobile phone, which is relatively small in physical size and therefore has only a very restricted space to accommodate the physical resources required to carry out the wide variety of device functions. The power source to power the device is also small in size but, nevertheless, is required to enable the device to operate or be held in a standby mode over relatively extended periods of time. A typical smart phone includes a CPU, read only memory (ROM), flash memory for storage of user data, random access memory (RAM), and input/output devices.

However, this form of computing device, both in terms of physical structure and its method of operation, is in strict contrast to PC or workstation type devices, which have significantly more physical resources at their disposal. For example, a smart phone CPU runs at a lower speed. Furthermore, the system ROM needs to contain the entire operating system, in comparison to a PC where only a bootstrap loader and BIOS are built into ROM, with the operating system and applications loaded from a hard disc. Moreover, the system RAM on a typical smart phone is limited to around 8 MB or 16 MB. Additionally there is no disc drive so there is no ability to make use of disc-backed virtual memory during device operation. Hence, the operating system software must be very compact in terms of code size, be very efficient in operation, and minimise the consumption of the power drawn from the restricted power source.

Most computing devices can only execute one program instruction at a time, but because they operate at high speed, they appear to run many programs and serve many applications simultaneously. Therefore, the operating system gives each selected program a “turn” at running on the device, but then requires the selected program to wait while another program is provided with a turn to run on the device. Each of these programs is viewed by the operating system as a task for which certain resources of the computing device are identified and monitored.

The operating system manages each program stored within memory in the device, such as for example spreadsheet, word processor, or web browser programs, as a separate task and typically will enable a user of the device to look at and control items on a task list. If the program initiates an input/output (I/O) request, such as reading a file or sending a message to a remote recipient, a thread is created. If the program initiates an input/output (I/O) request, such as reading a file or sending a message to a remote recipient, a thread is usually created. The time at which the thread is created can vary between one operating system and another. For example, some operating systems, such as the Symbian OS™ operating system available from Symbian Limited of London, England, use asynchronous I/O. This means that a thread making an I/O request is allowed to continue execution while the request is in progress and will be notified when the request completes. In general a new thread is created when the processing carried out by the program can be split into units such that it is advantageous for those units to execute, at least conceptually, in a concurrent manner. For example an application might use one thread for user interface (UI) processing and another for long-running operations initiated by a user. In this way the UI can still respond even while the long-running operation continues.

The data kept as part of a thread can allow, for example, a program to be re-entered at the correct location when a particular I/O operation is completed. Meanwhile, other concurrent uses of the program are maintained on other threads. Most current operating systems for computing devices provide support for both multitasking and multithreading. They also allow multithreading within program processes so that the system is saved the overhead of creating a new process for each thread.

Thread information may be maintained by storing in a special data area and putting the address of that data area in a register such as, for example, a stack pointer of the computing device. The operating system saves the contents of the register when the thread is interrupted and restores it when the thread is again given control.

The computing device operating system and its applications can be considered as being divided into various types of components, with different boundaries between these components. Certain of these components are commonly referred to as the kernel, and these components are used to manage the system Random Access Memory (RAM) and other hardware resources of the device. The kernel provides and controls the way all other software resources stored in the computing device can access these resources and provides certain services for all other parts of the operating system. The kernel components can, therefore, be contrasted with the outer or shell components of the operating system that interact with user commands.

The computing device operating system will, typically, create a number of different threads for use within the kernel. For example, an embodiment of the Symbian OS™ operating system creates five kernel threads at boot time of the computing device (although more may be created by extensions), and these kernel threads perform various tasks. One of these threads is the ‘Null’ thread and in Symbian OS™, this can be the first thread to run on the computing device at boot time. In this operating system the null thread is responsible for the first phases of operating system kernel initialisation.

The first major task of the null thread is to make the transition from a single-threaded execution model, which exists immediately after processor reset, to a multi-threaded execution model that exists when the kernel is fully initialised. Following this, the computing device memory management unit (MMU) is initialised (so that dynamic memory allocation is possible) and kernel chunks are created (so that new kernel objects and thread stacks may be created). Finally, a supervisor thread is created and caused to run. However, since the null thread has the lowest priority of all kernel threads, a reschedule of the initialisation sequence occurs immediately after creation of the supervisor thread and initialisation subsequently continues in the supervisor thread.

After the creation of the supervisor thread, the null thread will regain control of the computing device only when no other thread is ready to run. Generally, the null thread will simply loop forever executing a ‘wait for interrupt’ type instruction, which when received places the central processing unit (CPU) into a reduced power or idle mode, whereby instruction execution is stopped until a hardware interrupt is asserted. The null thread can also be used to turn off the entire computing device if no user activity is initiated within a prescribed interval. This power saving is particularly beneficial in smart phones, which are required to operate for extended periods from a relatively small battery power source.

As stated above, in a PC device, the majority of the device operating system and the system programs are stored on a hard disc. However, it is known in the PC computing art that fragmentation of files held on the hard disk occurs with recurrent use of the files. In essence, a file which starts as a single file entity on the disc is gradually transformed into a file in the form of a number of file segments which are not stored in a contiguous manner on the disc; i.e. fragmentation of the file has occurred as a result of the recurrent use. When such a fragmented file is loaded again for use, the operating system must first search for each fragmented segment and assemble them together before the file is finally ready for use. This process is time-consuming, reduces system performance and consumes memory space on the hard disc. Hence, fragmentation of stored files is less tolerable in a PC where the hardware resources, such as the processor speed or hard disc storage capacity, are relatively restricted.

In a PC device this problem can be alleviated by periodically using a dedicated disc defragmentation programme, which can be stored on the hard disc itself. When the programme is run, the defragmentation effected again provides contiguous storage of the file on the hard disc. Hence, the operating system can find and read the total file content faster than the scenario when the total file content is held as a plurality of non-contiguous file fragments. Especially on file servers or heavily accessed workstations, a performance gain of up to 100% can be reached.

However, in a smart phone, the total memory resources available to operate the device are in strict contrast to those available in a PC device. In particular, there is no hard disc drive because the power consumed in operating the drive would so severely limit the period for which the device would operate from the relatively small internal battery power source that the device would be considered unusable in practice. Hence, in a smart phone, the system programs are usually held in non-volatile solid state memory, such as flash memory because the memory contents are not lost in the event of power loss, or when the device is switched off. Increasingly, the device flash memory is in the form of NAND flash memory because of the operating speed and the relatively low power consumption exhibited by this type of memory. Additionally, NAND flash memory also has the further advantage of relatively low cost.

During device operation, the device dynamic RAM, which as stated above is of relatively restricted storage capacity, may be used for two purposes. Firstly, the dynamic RAM is used for temporary storage of active programs and also the device operating system, when this is required to be copied from the flash memory in the case when NAND flash memory is used, which does not support execute in place operation. This is in strict contrast to the hard disc storage available on a PC for this purpose.

Secondly, the dynamic RAM also serves as the device dynamic memory. In essence, therefore, the relatively low storage capacity RAM must serve not only as the relatively large capacity dynamic memory available on a PC but also as a substitute for the hard disc type virtual memory used to supplement the dynamic memory in the PC.

Thus, it can be appreciated that, in a smart phone, there is a very high demand placed upon this relatively scarce resource. The operating system is usually configured so that only as much RAM as is needed is used for each purpose, but in order to maximise the use of this relatively scarce memory resource, the operating system does not pre-allocate a certain amount of RAM for one purpose and a certain amount of RAM for the other purpose.

The type of RAM in widespread use in smart phones is Mobile SDRAM. This type of SDRAM is divided into several blocks (usually three) and may have self-refresh disabled selectively. For example, an 8 MB Mobile SDRAM device would typically allow 2 MB, 4 MB or 8 MB to be self-refreshed. Refreshing of the memory consumes power and is dependent on the size of memory being refreshed. It follows that to refresh 8 MB of memory consumes considerably more power than to refresh 2 MB of memory.

Files may be stored in SDRAM as page frames and a typical single page frame can be of 4 KB in size. However, fragmentation of page frames in SDRAM occurs in a similar manner to the files held on the hard disc of a PC and hence one or more page frames used to run an application may be held in one block of the SDRAM and other page frames to run the application may be held in one or more of the other blocks of the SDRAM. Therefore, taking as an example an SDRAM of 8 MB capacity and divided into three blocks, if the total RAM actually in use is less than 2 MB but, because of the dispersion of the page frames arising from fragmentation, this used RAM is spread over all three blocks, then all 8 MB of the RAM need to be refreshed. In contrast, if the page frames in use are defragmented such that they are contiguous, only 2 MB of the RAM need to be refreshed. Because the amount of power consumed during refreshing is dependent on the size of memory being refreshed, it can be seen that it is advantageous to defragment the page frames held in the RAM such that all the used RAM lies in the first 2 MB of the physical address range. Then, when the system is idle, there is no need to refresh the remaining RAM and power is saved, thus extending the standby time of the smart phone.

With the present invention defragmentation of the RAM is arranged to occur when the device is controlled by the null thread, so there is no impact on system performance.

The null thread is scheduled to cause the device to adopt a reduced power mode because no other thread is sensed as being ready to run. The null thread usually places the device CPU in a standby condition in this reduced power mode and this is possible because only the null thread is required to run on the device. However, with the present invention, when the null thread is scheduled, the CPU is not initially placed in its standby condition. Instead, if it is required, the system RAM is defragmented and this can be achieved in a very efficient manner because the device physical resources, including the CPU, can be dedicated to this task. Hence, defragmentation of the RAM can be achieved relatively quickly and there is no impact on system performance. If defragmentation is completed prior to a thread other than the null thread being ready to run, then the CPU of the device can be placed into the standby mode. If defragmentation is not complete and a hardware interrupt is asserted then the CPU is not placed into the standby mode but reverts to handling of the new threads which are ready to run.

The actual defragmentation steps, once initiated, may be achieved according to any convenient process. SDRAM, for example, stores data in the form of physical frame pages, which might be held in all blocks of the memory space. Therefore, the data stored at a high physical in the memory space would be moved to one at a low physical address, and this process would be repeated, moving each page of data independently of the others, until all of the frame pages in use form a contiguous sequence of frame pages at the bottom of the physical address space.

The null thread can be arranged to include additional code that runs as part of the null thread to perform the defragmentation. Alternatively, the null thread can contain code that initiates a further independent code sequence to perform the defragmentation. Additionally, defragmentation of the page frames can be arranged to selectively occur during running of the null thread such that the defragmentation process will only take place when the page can be held in a reduced number of blocks within the memory, in comparison to the number of blocks required to hold the frame pages before defragmentaion. For example, in the case of the 8 MB memory device described above, if the total system RAM in use when the null thread is sequenced to run is 2.5 MB and this is all in the first 4 MB of the memory space, then defragmentation of the RAM would not be initiated because the RAM in use cannot be restricted to the first 2 MB block and thus, the first 4 MB of the total memory space would continue to self refresh, even if the defragmentation process had been carried out.

The present invention has been described with particular reference to defragmentation of RAM memory. However, the method can also be used for the defragmentation of other forms of memory device, including disc drives. Also, it is pointed out that the method of the present invention can be used for any type of read/write memory, including dynamic RAM, and NOR and NAND flash memory.

Although the present invention has been described with reference to particular embodiments, it will be appreciated that modifications may be effected whilst remaining within the scope of the present invention as defined by the appended claims.

1. (canceled)

2. A method according to claim 11 wherein the said thread is arranged to contain code for performing the defragmentation of the data.

3. A method according to claim 11 wherein the said thread is arranged to contain code for causing a further code to perform the defragmentation of the data.

4. A method according to claim 11 wherein the said thread comprises a thread of operating system code for causing the computing device to adopt a reduced power mode by placing a central processing unit of the computing device into a standby mode, thereby to further reduce the power consumer from the power resources of the computing device.

5. A method as claimed in claim 11 wherein the said thread comprises the thread which is arranged to be the first thread to run at boot time of the computing device.

6. A method according to claim 11 wherein the computing device is selected to comprise a wireless information device.

7. (canceled)

8. (canceled)

9. (canceled)

10. (canceled)

11. A method of managing in a computing device the use of random access memory arranged in the form of a plurality of blocks and used to store data in the form of a plurality of frame pages, the method comprising using a thread of operating system code which is arranged to run on the computing device when no other thread is ready to run to initiate defragmentation of the data, and characterised by restricting defragmentation of the data to when it is determined that the frame pages of data after defragmentation can be held in a reduced number of blocks of memory in comparison to prior to defragmentation, thereby to reduce the number of blocks of the memory used to store the frame pages of data and requiring to be refreshed, and thereby reduce the power consumed from the power resources of the computing device to store the said data.

12. A computing device programmed to operate according to the method of claim 11.

13. Computer software arranged to cause a computing device to operate according to a method according to any claim 11.
